(19) United States
(12) Patent Application Publication
(10) Pub. No.: US 2011/0078071 A1
(43) Pub. Date: Mar. 31, 2011

(54) PRIORITIZING LOANS USING CUSTOMER, PRODUCT AND WORKFLOW ATTRIBUTES

(75) Inventors: Chitra Dorai, Chappaqua, NY (US); Jane D. Hoffmann, Huntersville, NC (US); Daniel N. Johnson, Cornelius, NC (US); Milind R. Naphade, Fishkill, NY (US); Qihong Shao, Tempe, AZ (US); Anshul Sheopuri, Hartsdale, NY (US)

(73) Assignee: INTERNATIONAL BUSINESS MACHINES CORPORATION, Armonk, NY (US)

(21) Appl. No.: 12/567,064

(22) Filed: Sep. 25, 2009

(51) Int. Cl. G06Q 40/00

(52) U.S. Cl. 705/38

(57) ABSTRACT

Data representative of a plurality of mortgage applications is obtained. The applications participate in a mortgage origination process, and each of the applications has associated therewith customer-specific attributes and product-specific attributes. The mortgage origination process has a plurality of statuses. Data representative of at least one environmental attribute is also obtained. Each given one of the mortgage applications in a given one of the plurality of statuses at a given time is ranked by likelihood of not closing, based at least on the customer-specific attributes, the product-specific attributes, and the at least one environmental attribute. Those of the mortgage applications likely not to close which are likely not to close due to non-exogenous attributes are identified. For at least some of the mortgage applications likely not to close due to non-exogenous attributes, suggestion of a modification of at least one corresponding one of the product-specific attributes is facilitated, to enhance the likelihood of closing.

### FIELD OF THE INVENTION

The present invention relates to the computer and data processing arts, and, more particularly, to data processing techniques for mortgage applications and the like.

### BACKGROUND OF THE INVENTION

Mortgage Origination (MO) is the end-to-end process beginning with the submission of a mortgage application to a lender and ending in closing (lender approves, applicant accepts and lender funds the loan) or non-closing (either lender disapproves, or applicant withdraws or refuses approved offer by lender). Heretofore, classification techniques have been applied to the mortgage industry in the context of mortgage delinquency. For example, J. Wong et al., in “Residential mortgage default risk and the loan-to-value ratio,” Hong Kong Monetary Authority Quarterly Bulletin December 2004, 35-45, study the problem using logistic regressions. G. John and Y. Zhao, in Mortgage data mining, Computational Intelligence in Financial Engineering, 232-236, 1997, discuss the performance the Radial Basis Function (RBF), which combines the mathematical complexity of neural networks with a comprehensive visualization for mortgage scoring. R. Gerritsen, Assessing loan risks: A data mining case study, IT Pro, 1999, is a case study of various data mining models to assess mortgage risks pertaining to delinquency.

### SUMMARY OF THE INVENTION

Principles of the present invention provide techniques for prioritizing loans using customer, product and workflow attributes. In one aspect, an exemplary method (which can be computer implemented) includes the step of obtaining data representative of a plurality of mortgage applications. The applications participate in a mortgage origination process, and each of the applications has associated therewith customer-specific attributes and product-specific attributes. The mortgage origination process has a plurality of statuses. Additional steps include obtaining data representative of at least one environmental attribute; and ranking each given one of the mortgage applications in a given one of the plurality of statuses at a given time, by likelihood of not closing, based at least on the customer-specific attributes, the product-specific attributes, and the at least one environmental attribute. Still further steps include identifying those of the mortgage applications likely not to close which are likely not to close due to non-exogenous attributes; and facilitating suggesting, for at least some of the mortgage applications likely not to close due to non-exogenous attributes, a modification of at least one corresponding one of the product-specific attributes, to enhance a likelihood of closing.

One or more embodiments of the invention or elements thereof can be implemented in the form of a computer product including a computer readable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a computer readable storage medium (or multiple such media).

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows a table of typical pull-through rates;

FIG. 2 shows a workflow representation;

FIG. 3 shows a workflow of a sample loan;

FIG. 4 shows exemplary loan outcome by credit score;

FIG. 5 shows exemplary performance of models with customer and product attributes;

FIG. 6 shows PR curves with customer and product attributes;

FIG. 7 shows PR curves with customer, product and environment attributes;

FIG. 8 shows LR model performance with customer, product and environment attributes;

FIG. 9 shows PR curves with customer, product, environment and workflow attributes;

FIG. 10 shows exemplary robustness of ranking results;

FIG. 11 shows selected attribute values and the corresponding scores for an exemplary application Y;

FIG. 12 shows LR model performance with customer, product, environment and workflow attributes;

FIG. 13 shows an exemplary block diagram, according to an aspect of the invention;

FIG. 14 shows a flow chart of an exemplary method, according to another aspect of the invention; and

FIG. 15 depicts a computer system that may be useful in implementing one or more aspects and/or elements of the invention.

### DETAILED DESCRIPTION OF PREFERRED EMBODIMENTS

One or more embodiments of the invention enable analysis of the performance of an end-to-end Mortgage Origination (MO) process. The process begins with the submission of a mortgage application by an applicant to a lender and ends with one of the following outcomes: closing, i.e., loan approved by the lender and accepted by the applicant; or non-closing, i.e., loan either rejected by the lender, or approved by the lender and not accepted by the applicant. Ranking mortgage applications by their predicted likelihood of closing at various steps in the process is useful for process efficiency and identification of actionable insights to convert applications likely to non-close into those that are likely to close.

To build models for ranking applications at any step of the MO process, one or more embodiments take into account customer and product specific attributes of the applications as well as environment attributes and the history of the applications or workflow. In one or more embodiments, the large state-space of the workflow requires appropriate attention to the ranking problem. One or more instances employ two workflow attributes, each with a state-space of dimension one, based on the number of visits to any step and a particular step (re-work) respectively. In a non-limiting example, incorporating these workflow attributes into a density modeling technique disclosed herein results in improvement of 4.8 percent in average precision over models that only incorporate customer, product and environment attributes. This figure is non-limiting, and better, comparable, or worse results might be obtained in other instances (in general, this applies to all examples herein). In one or more embodiments, the simple and scalable density modeling technique allows for easy identification of applications that are likely to non-close and consequent corrective action such as change in the attributes of the mortgage product being offered. Further, in a non-limiting example, results indicate that one embodiment of the model is comparable to support vector machines and superior to logistic regression for ranking.

As noted above, Mortgage Origination (MO) is the end-to-end process beginning with the submission of a mortgage application to a lender and ending in closing (lender approves, applicant accepts and lender funds the loan) or non-closing (either lender disapproves, or applicant withdraws or refuses approved offer by lender). Herein, the terms mortgage application and loan are used interchangeably to refer to an application submitted by a customer to a lender for approval. One or more embodiments provide models for ranking applications, taking into account customer, product and environment attributes as well as the history of applications or workflow. Developing ranking models not only enables process efficiency but also allows for identification of applications that may have a high likelihood of non-closing but whose likelihood of closing may be improved through “corrective action.” The specific nature of corrective action is dependent on the lending institution. It could include, for example, a change in the attributes of the mortgage product being offered. Such an action might lead to a higher conversion rate of applications submitted into applications closed. This pull-through rate is defined as the ratio of the number of applications that close to those that are submitted.

As shown in the table of FIG. 1, the typical pull-through rates in the industry may be quite low for some channels, thus offering considerable scope for improvement. Furthermore, the MO process may involve several dozens of tasks or statuses, and thus, the problem of ranking applications in the process in order of likelihood of closing, at an intermediate status, is nontrivial. Some applications re-visit their status, making the ranking problem involved.

As stated above, each application typically contains customer attributes like credit score and product attributes such as loan amount. Environment attributes such as the U.S. federal rate may also affect the outcome of the loan. The workflow history incorporated to rank applications, in one or more embodiments, will now be illustrated with an example. Consider the Underwriting-Pending Approval Completion task in the MO process of a service provider. Suppose that there are two applications, A and B, waiting to be reviewed at this status. For simplicity, consider only Credit Score and workflow history while comparing the two applications. Suppose that application A has a Credit Score of 712 while application B has a Credit Score of 662. However, the history of application A, so far, reveals that it has undergone considerable re-work, i.e., it has traversed the loop, Underwriting-(Initial) Review, Underwriting-Pending Approval Completion and Underwriting—Exception Review two times, possibly due to insufficient employment proof. On the other hand, application B has undergone no re-work. The question arises as to how one might compare the likelihood of closing of applications A and B. Thus, the large state-space of the workflow attribute makes the problem of ranking applications, in order of likelihood of closing, challenging.

One or more embodiments employ two workflow attributes, each with a state space of dimension one, based on the number of visits to any status and a particular status (re-work) respectively. In a non-limiting example, incorporating these workflow attributes results in improvement of the density modeling technique set forth herein by 4.8 percent in average precision over models that only incorporate customer, product and environment attributes. In at least some instances, incorporating environment attributes such as the U.S. federal interest rate results in improvement of the density modeling technique over those models that consider only customer and product specific attributes. The simple and scalable density modeling technique allows for easy identification of applications that are likely to non-close and consequent corrective action such as change in the attributes of the mortgage product being offered. Further, non-limiting exemplary results indicate that an embodiment of the model is comparable to support vector machines and superior to logistic regression for ranking.

### Notation

In this section, the relevant notation is introduced and an exemplary statement of the problem of ranking applications at any status, taking into account the customer, product, environment and workflow attributes of applications, is provided. First, represent the MO process by a directed graph whose vertices are the status or tasks of the process and whose edges are possible transitions between statuses. Associated with each application is a unique identifier. The problem of prioritizing applications at each status can be treated as an optimization problem, whose objective function is a metric for ranking models and whose decision variables are ranks associated with each application waiting at the status of interest. In order to state the problem, consider the notion of history of the applications at an epoch of time to be a set that contains information pertaining to the sequence of status visited by all applications up to that time.

Represent the workflow of the MO process by a strict digraph, G. Let V(G) and E(G) denote the set of vertices and edges of G respectively. Define the history of applications at time T, H_{T} to be the set of triplets of the unique identifier corresponding to the loan, statuses and entry times into those statuses. H_{T} uniquely determines the history of all applications that have been processed and those that are being processed till time T. Refer to H_{T} as the state of the process at time T:

[symbol]

_{T}={(i, v, tᵢᵥ)|tᵢᵥ≦T, i ∈ [symbol] , v ∈ V (G)} (1)

where S is the set of unique identifiers of all applications.

Let P_{Tv} be the set of unique identifiers of applications waiting to be processed at status v at time T. Let the cardinality of P_{Tv} be n. Let 1≦y(i)≦n, where y(i) is an integer, be the rank of application i (the unique identifier i of an application is referred to herein as application i). In particular, if y(i)<y(j), then application i has a higher rank than application j at status v.

Let M be a metric (to measure the performance of a ranking model) that it is desired to maximize. Then, the objective is to assign a rank to each application at status v at time T in order to maximize M, i.e.,

max_{y}(ᵢ),i∈ [symbol] hd Tv

subject to

y(i)≠y(j) ∀ i, j ∈ [symbol] _{Tv}. (2)

### Process and Data

A number of experiments have been conducted using data obtained separately from an actual lending process. The experimental results are presented for purposes of illustration and not limitation. All data used in the experiments was anonymized to protect customer confidentiality.

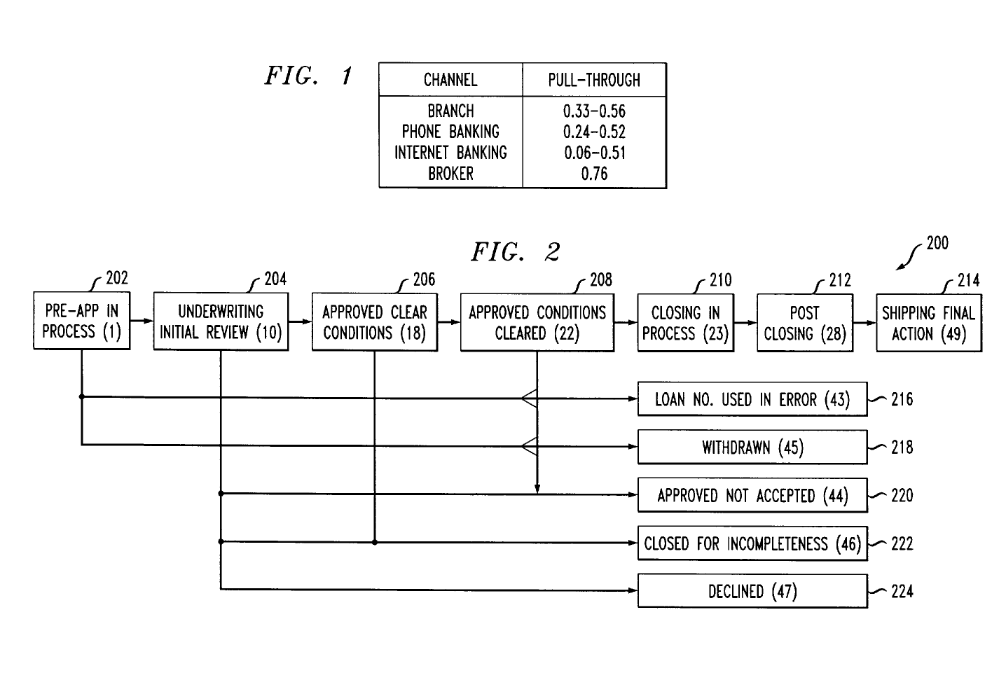

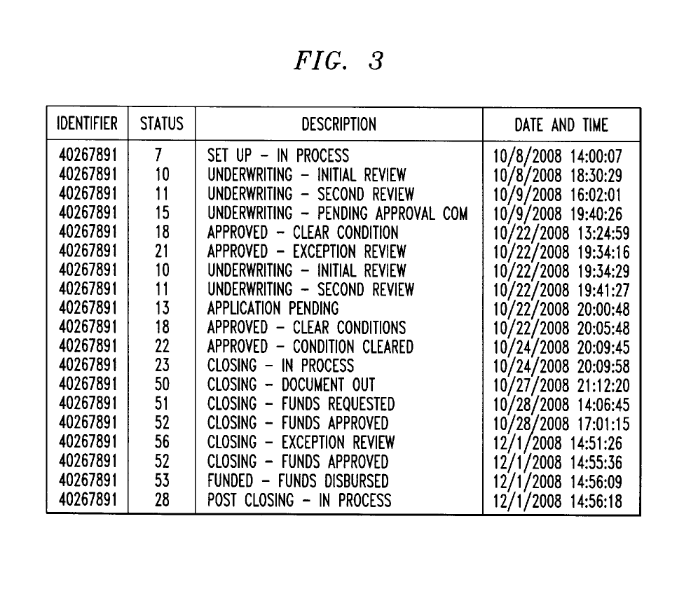

Process Description: The end-to-end MO process of an exemplary lender involves 57 statuses. FIG. 2 is a simplified representation of the process flow 200 with all the closing and non-closing statuses. Statuses include pre-app in process (1), reference character 202; underwriting initial review (10), reference character 204; approved clear conditions (18), reference character 206; approved conditions cleared (22), reference character 208; closing in process (23), reference character 210; and post closing (28), reference character 212. There is one closing status 214 (Shipping—Final Action, status 49) and there are five non-closing statuses:
Loan Number Used in Error (43), reference character 216
Withdrawn (45), reference character 218
Approved Not Accepted (44), reference character 220
Closed for Incompleteness (46), reference character 222
Declined (47), reference character 224

Data Description: Experiments were carried out on an anonymized data set from 1332 mortgage applications; again, all data used in the experiments was anonymized to protect customer confidentiality. For each of these applications, it is known whether the application has closed or not. The data attributes that were available can be classified into four types:
i. Customer-specific attributes—these include:

(a) Credit score.

(b) (Assets—Liabilities)/Income. If income is considered on a per monthly basis, then the quantity (Assets—Liabilities)/Income corresponds to the number of months of income that are required to accrue the net assets of the individual.

(c) Appraised Value—Sale Price. The appraised value of a property corresponds to its assessed value by a qualified appraiser. The sale price pertains to the price that is being paid for the property. Thus, the difference between Appraised Value and Sale Price, i.e., Appraised Value—Sale Price corresponds to the “benefit” that is realized by paying less for the property than what it is worth.

(d) Debt to Income.
ii. Product-specific attributes—these include:

(a) Rate Type. A variable interest rate is one that is linked to the movement of an index of interest rates. A fixed interest rate, on the other hand, is pre-determined and does not change during the tenure of the loan. Rate type is a binary variable corresponding to whether a loan has a variable interest rate or a fixed interest rate.

(b) Interest Rate.

(c) Property Type. Applying for a secured loan to pay off a different loan secured against the same asset is called refinancing. Property type is a binary variable corresponding to whether a loan is purchase or refinance.

(d) Loan amount is the amount of the loan requested.

(e) Cashout is a binary variable corresponding to whether the applicant receives money or pays money at the end of the transaction, if accepted.

(f) Loan to Value.

(g) Finance charge, a binary variable indicating if additional finance charges are applicable.
iii. Environment attributes: The U.S. federal interest rate is extracted from the Federal Reserve website biweekly.
iv. Workflow attributes—these include data pertaining to the history of status changes of applications along with the time that status is entered. Consider, for example, the sequence of status changes of an application up to a certain epoch of time, as in FIG. 3, along with a description of the statuses and corresponding entry times. As a first step to building models to rank applications at any status, consider initially how to rank applications using customer and product-specific attributes only. Based on the insights that derived from such analysis, consider models that incorporate environment attributes and workflow.

### Customer and Product Attributes Based Ranking Analysis

Consider ranking of applications with customer and product attributes of applications. If the training data set is large enough, one can estimate the joint cumulative distribution function (c.d.f.) of X₁, X₂, . . . Xₘ of all applications that close, where {X₁, X₂, . . . Xₘ} is the set of customer and product specific attributes. One or more embodiments leverage this distribution to prioritize the applications using an appropriate Scoring function and sorting the applications according to their scores. One such intuitive Scoring function may be the joint c.d.f. or probability density function (p.d.f.) itself.

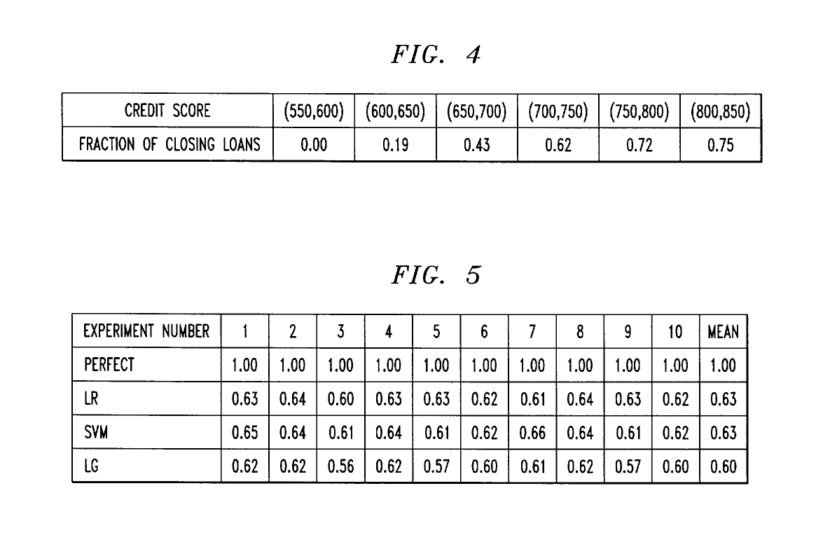

In one or more embodiments with a limited-size data set, assume that X₁, X₂, . . . Xₘ are independent in order to estimate the joint c.d.f. For simplicity of discussion, consider only one variable, for example, Credit Score, and inquire whether it might be better to use either the c.d.f. or p.d.f. for scoring. First note that Credit Score is positively correlated with a Bernoulli random variable which equals one when the outcome is close and zero if it is non-close. The table of FIG. 4 provides the fraction of closing applications, by Credit Score intervals, in an exemplary training data set. Consequently, using a scoring function that is monotone increasing in the Credit Score may be preferable for prioritizing applications. Similarly, for some other variables (for example, interest rate), using a scoring function that is monotone decreasing in the interest rate may be preferable for prioritizing applications.

The set of customer and product specific attributes may be partitioned into two sets, I and D, such that the scoring function is increasing (decreasing) in each variable in I (D) independently. Thus, based on the assumption of independence of attributes, score an application with Xᵢ=xᵢ, i=1, 2, . . . m by:

$$\frac{{\prod }_{i ∈ I} {F}_{ic} ( {x}_{i} ) \cdot {\prod }_{i ∈ D} ( 1 - {F}_{ic} ( {x}_{i} ) )}{{\prod }_{i ∈ I} ( 1 - {F}_{in} ( {x}_{i} ) ) \cdot {\prod }_{i ∈ D} {F}_{in} ( {x}_{i} )} , \qquad ( 3 )$$

where F_{ic}(.) (Fᵢₙ(.)) is the c.d.f. of Xi estimated from the training data set and corresponding to the applications that close (non-close) only. Refer to this ranking method as Likelihood Ratio (LR).

Note that LR is a simple and scalable ranking model. It also allows for easy identification of attributes that cause an application to non-close with a high likelihood and suggest corrective action.

Purely for purposes of a non-limiting exemplary comparison, compare the performance of LR with Support Vector Machines (SVM) (one or more embodiments use C-SVC—regularized support vector classification with RBF (radial basis function) Gaussian kernel), Logistic Regression (LG) and that of a perfect ranking model, i.e., a model that ranks all relevant applications above non-relevant applications and a first-in first-out (FIFO) model, i.e., a model that ranks applications at a status in the order in which they are received at that status (one or more embodiments use classification methods such as SVM to train, ranking applications in the test data set by their likelihood of closing). Compute non-parametric estimates of the attributes to estimate the performance of LR. Consider whether some attributes belong to well-known parametric distribution families. A chi-squared test at 95 percent significance reveals that (Assets—Liabilities)/Income is normally distributed. However, it was not possible to determine the distribution of several attributes at 95 percent significance. Estimates of the distribution of all attributes were computed, assuming them to be Normal and independent. Since the performance of the models with the nonparametric assumption was inferior to that with the Normal distribution assumption, in the non-limiting example presented, the results for that case are omitted. Herein, models with the Normal distribution assumption are referred to as LR.

Purely for illustrative purposes, to evaluate the performance of exemplary ranking methods, employ Precision-Recall (PR) curves. In order to enable comparison of two Precision-Recall curves, I and II, note that curve I dominates curve II if the precision, at every value of recall, is lower for curve II than curve I. The skilled artisan will be familiar with same from, for example, F. Provost et al. “The case against accuracy estimation for comparing induction algorithms,” ICML, 1998; and J. Davis and M. Goadrich, “The relationship between precision-recall and roc curves,” Technical Report, University of Wisconsin-Madison, 2006, and will be able, based on the teachings herein, to employ same in an appropriate fashion. To enable easy quantitative comparison, also use ranking metrics. Different metrics have been used for evaluating the performance of ranking models, the most popular of which is Average Precision. The skilled artisan will be familiar with same from, for example, J. Aslam et al. “A geometric interpretation of r-precision and its correlation with average precision,” SIGIR, 2005, and will be able, based on the teachings herein, to employ same in an appropriate fashion.

One or more embodiments address retrieving two ranked lists, one with non-closing applications as relevant and the other with closing applications as relevant. In this non-limiting example, consider the first case, i.e., non-closing applications as relevant. The insights for the second case are similar in terms of which models perform better, and such results are omitted for brevity.

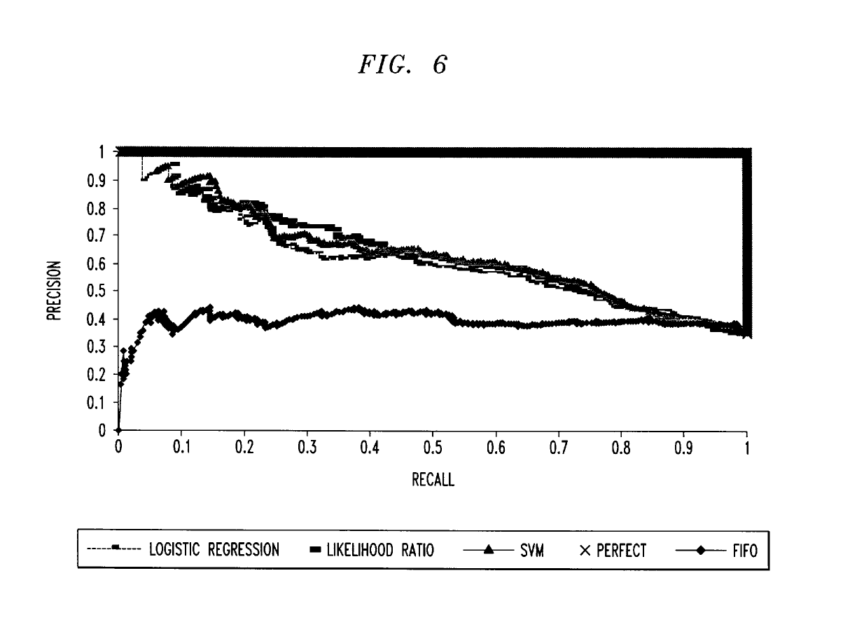

Consider the performance of LR, SVM and LG. The Precision-Recall curves for these three methods, along with FIFO and Perfect, are provided in FIG. 6. The PR curve for none of the three methods dominates another method. However, among the three methods, the performance of LR and SVM is comparable and dominates LG on mean Average Precision over the ten sets of experiments that are considered, as shown in the table of FIG. 5. Further, LR and SVM outperform FIFO by 65% on mean Average Precision.

The results above indicate that in at least some instances, the LR and SVM methods are comparable and significantly outperform FIFO. Hereinafter, when the effects of environment and workflow attributes are considered, results are presented for LR only, for brevity.

### Customer, Product and Environment Attributes Based Ranking Analysis

Consider the effect of environment attribute(s) on the performance of ranking models. As used herein, “environment attributes” are those attributes that are exogenous to the customer, the product and the process. Several environment attributes may be of interest, such as the U.S. federal interest rate, marketing campaigns, competition, and so on. In the illustrative embodiment(s) here, the only environment attribute considered is the U.S. federal rate, it being understood that other environmental attributes could be addressed in a similar fashion.

Consider why U.S. federal interest rate may be of interest. Firstly, note that consumers are more likely to take a loan on a house when the U.S. federal interest rate is low. Homeowners also typically refinance in low interest rate regimes. Secondly, plotting the U.S. federal interest rate as a function of time reveals that there has been significant volatility in the rate recently (the period corresponding to the exemplary data set). Thus, the impact of this attribute is expected to be more significant than if the data were from periods of lower volatility.

The federal interest rate(s) of interest may be obtained from the United States Federal Reserve.

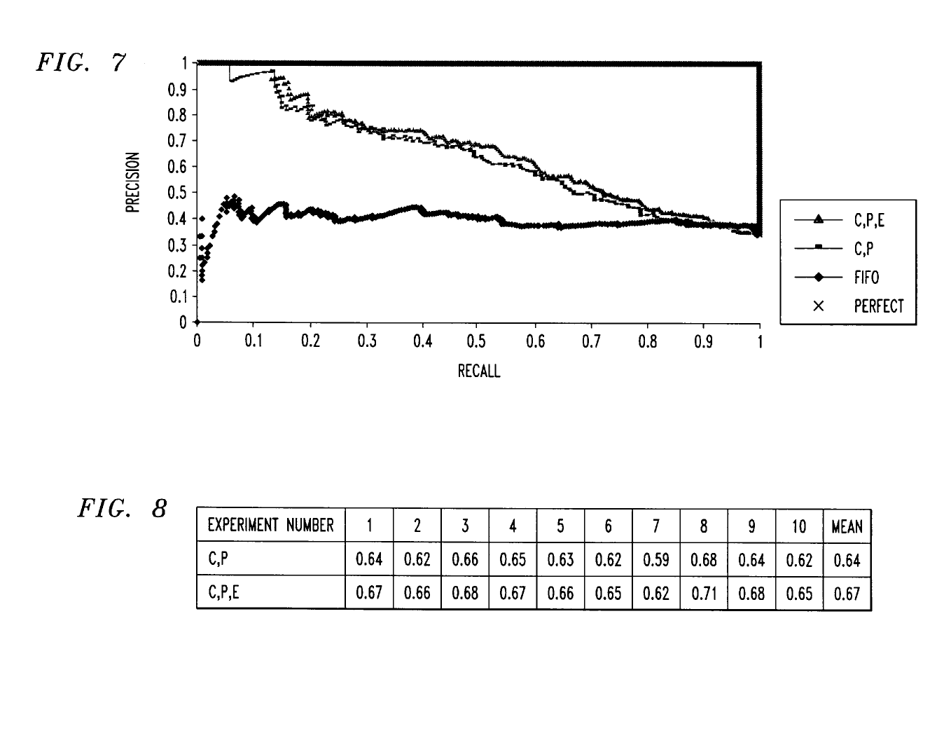

FIG. 7 shows the Precision-Recall curves for an LR model with and without environment attributes. In FIG. 7, the legend C,P (C,P,E) refers to an LR model with customer and product (customer, product and environment) attributes. Note that neither curve dominates the other. However, the experiments indicate that the mean Average Precision over ten sets of experiments improves by 4.6% on incorporating this attribute (see the table of FIG. 8). It is believed that the magnitude of effect of this attribute on the accuracy of the ranking models would be much lower in periods of lower volatility.

### Customer, Product, Environment and Workflow Attributes Based Ranking Analysis

Consider ranking applications at an intermediate status, and whether it is possible to improve the performance of ranking models that use only customer, product and environment attributes by leveraging historical state information. Use status u as a generic status for which a ranking model is being developed. Recall that the historical information available at time T is given by equation (1). In at least some instances, the large state space of the history of the applications makes the analysis intractable. Thus, one or more embodiments employ two attributes, each with a state-space of dimension one, for any application. The reduced state space captures information pertaining to (1) the number of visits to status u, the status for which the ranking model is being built, and (2) the number of visits to any status. In at least some cases, the reduced state space may not be a sufficient statistic.

Define the number of visits to status u by application I as

lᵢᵤ=|{(i, u, tᵢᵤ)|tᵢᵤ≦T, i ∈ [symbol] , u ∈ V(G), (i, u, tᵢᵤ) ∈ [symbol] _{T}} (4)

where |Y| denotes the cardinality of set Y. In the sequel, drop the subscripts u and i and refer to lᵤᵢ as Visits1, for ease of presentation. Similarly define Visits2, the number of visits to any status.

The attribute Visits1 was chosen because applications which have considerable re-work are the ones that are likely to non-close. The attribute Visits2 was chosen since the data revealed that applications that close pass through a significantly greater number of unique statuses. Other attributes can be used in other cases.

Consider how to construct the test data set. Begin with the test data set, DA that was used for evaluating models in the section “Customer, Product and Environment Attributes Based Ranking Analysis.” For ease of exposition, additional notation to explain this construction is not introduced. Recall that ranking models are built at time T at status u. Thus, construct a subset of the applications of DA that are waiting to be processed at status u at time T, irrespective of whether they have been processed at status u before time T or not. Unfortunately, this constraint reduces the number of applications in the test data set DA significantly since (1) the data set contains applications over a one year period and, at any time, only a fraction of applications are being processed, and (2) the process contains over four dozen tasks and at any time, of the fraction being processed, only a fraction are at status u. Other conditions might be found in different sets of data.

To address this issue, in one or more embodiments, construct an approximate test data set. Relax the constraint (2) (that is, loans being processed at state u) and consider all applications that are being processed at time T and which belong to DA. Note that an alternative approach could be employed, i.e., relax constraint (1) (that is, loans being processed at time T) and consider all applications with either one entry or multiple entries in the test data set corresponding to each visit to status u. However, the alternative approach, in at least some cases, introduces additional uncertainty as compared to the first approach (If one entry corresponding to each visit to status u for each application were to be included, the question of which entry it would be has to be addressed. Similarly, if all entries in the test data set were to be included, it becomes biased towards applications with multiple visits to status u).

Consider now how to incorporate the workflow information pertaining to Visits1 into the LR model that was discussed in the section “Customer, Product and Environment Attributes Based Ranking Analysis.” Visits2 can be incorporated in a similar manner. For the purpose of building the model, Visits1 may be thought of as “just another independent attribute” and added to these models. However, while evaluating the score of an application at time T, in at least some cases, the fact that the number of visits information that is available is partial needs to be considered, i.e., if it is known that at time T, an application has made two prior visits to status 10, all that is known is that it will make two or more visits by the time it is processed. Thus, while evaluating the score of an application based on this partial information, the conditional probability of the number of visits to state u should be incorporated. Suppose that l visits were made to status u prior to time T. The following term when multiplied by the score of the LR model, i.e., expression (3), provides the new score:

$$\frac{{\sum }_{j = l}^{∞} P ( {L}_{c} = j / {L}_{c} \geq l ) \cdot {Score}_{u} ( {L}_{c} = j )}{{\sum }_{j = l}^{∞} P ( {L}_{nc} = j / {L}_{nc} \geq l ) \cdot {Score}_{d} ( {L}_{nc} = j )} , \qquad ( 5 )$$

where L_{c}(L_{nc}) is a random variable of the number of visits made by a closing (non-closing) application to status u estimated from the training dataset and Scoreᵤ(L_{c}=j) is the score if exactly j visits were made to state u. Similar to the logic that was applied in the section “Customer, Product and Environment Attributes Based Ranking Analysis,” define Scoreᵤ(X=x)=P(X≧x) and Score_{d}(X=x)=1−P(X≧x). To incorporate workflow into SVM, while evaluating the score of an application at time T which has made l visits to state u and whose predicted score by the trained model is Scoreₛᵥₘ(L=l), make the following correction to account for the partial information observed:

Σⱼ₌ₗ^{∝} P(L=j/L≧l)·Scoreₛᵥₘ(L=j), (6)

where L is a random variable corresponding to the number of visits made by an application to status u.

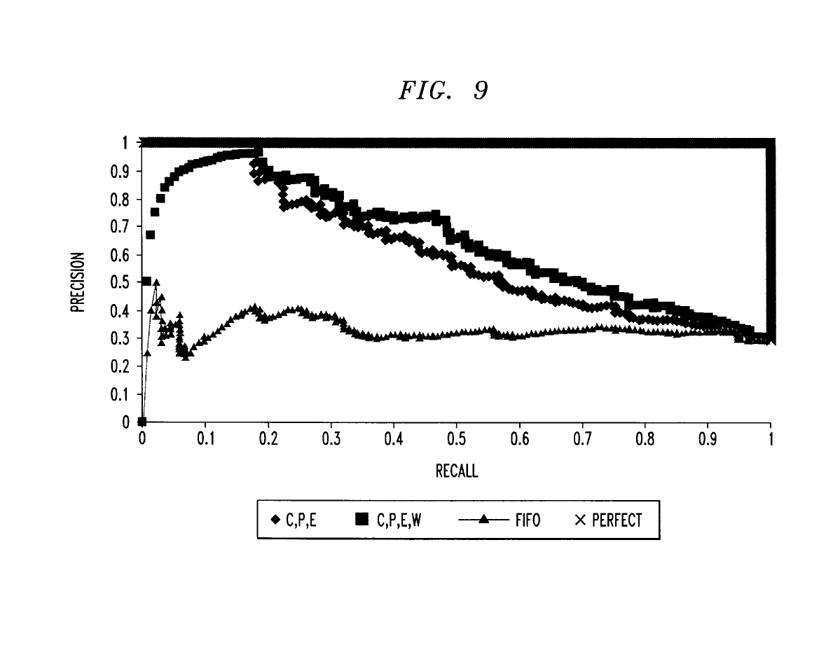

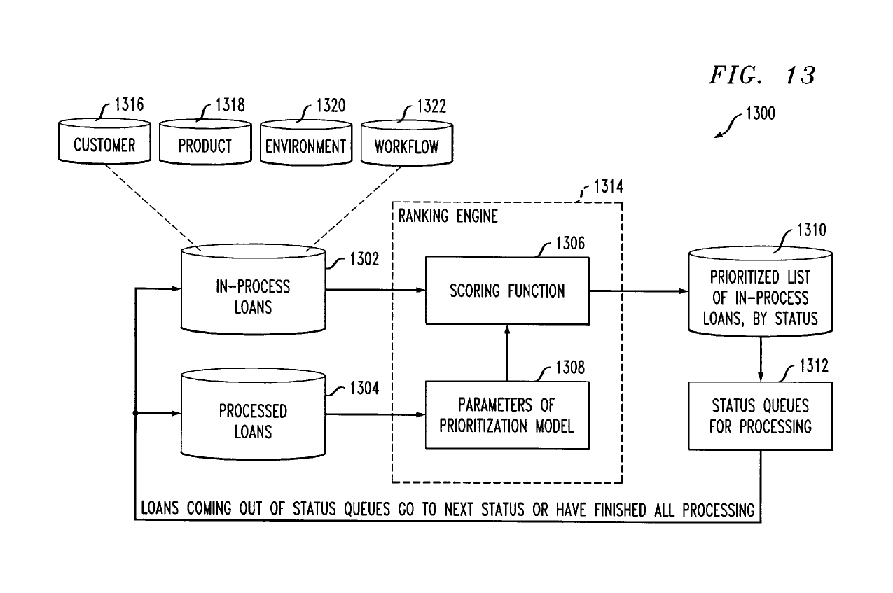

Consider now the performance of LR with workflow attributes for one epoch of time at status 10 at which the test data set was constructed, as shown in FIG. 9. Visits1 was found to be a Geometric random variable with parameter 0.7 through a chi-squared test. In FIG. 9, the legend C,P,E (C,P,E,W) refers to an LR model with customer, product and environment (customer, product, environment and workflow) attributes. Note that neither curve dominates the other. However, on the mean Average Precision metric, a 4.8% improvement is noted over ten sets of experiments, as in the table of FIG. 12. Thus, it may be concluded that the workflow attributes set forth herein have significant explanatory power for ranking, in one or more embodiments.

Recall that the results pertaining to the ranking models presented above were for one snapshot of time. To evaluate the robustness of the results, experiments were repeated at four epochs, say, t₁; t₂; t₃; t₄ at status 10 for LR with the workflow attribute. A summary of the results, presented in the table of FIG. 10, shows that the performance is comparable at all four epochs.

### Exemplary Application

It is believed that MO service providers will have an interest in the ranking models, as well as in identifying attributes that are “responsible” for causing an application not to close. Further, for identified attributes which are actionable, i.e., not exogenous, appropriate corrective action can be suggested so as to increase the likelihood of closing, thus improving the pull-through rate.

The results presented in the section on “Customer and Product Attributes Based ranking Analysis” demonstrate that in at least some instances, the LR model is comparable to SVM and outperforms LG. Not only do these models perform well; they also have the added advantage of allowing easy “attribute-wise comparison.”

Consider one scheme for resolving the problem of attribute identification for LR using customer and product attributes: Let sᵢ be the score associated with attribute Xᵢ=xᵢ, i=1, 2, . . . m for some application, i.e.,

$${s}_{i} = \frac{{F}_{ic} ( {x}_{i} )}{1 - {F}_{inc} ( {x}_{i} )} ∀ i ∈ I and {s}_{i} = \frac{1 - {F}_{ic} ( {x}_{i} )}{{F}_{inc} ( {x}_{i} )} ∀ i ∈ D . \qquad ( 7 )$$

For ease of presentation and without loss of generality, assume, in this section, that s₁≦s₂ . . . ≦sₘ. A corrective action that can be employed in some instances is to increase or decrease the value of attribute X₁, keeping other attribute values fixed, so that s₁=s₂. If X₁ is a discrete random variable, then change the value of the attribute just enough such that s₁≧s₂. For ease of exposition, this issue is not addressed herein; however, given the other examples herein, the skilled artisan will readily be able to address same.

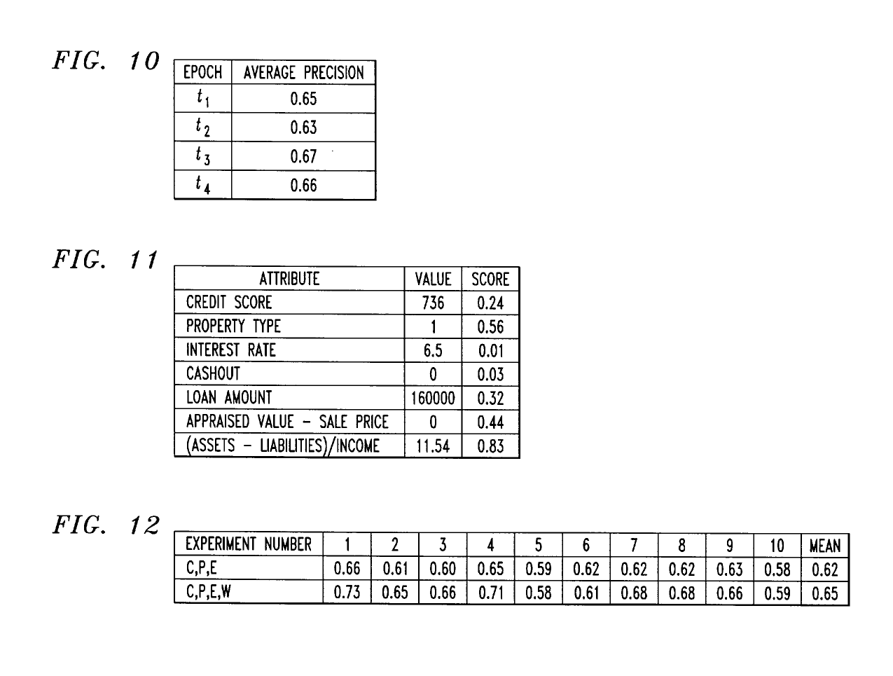

By way of a non-limiting example, consider an application, say Y, which has been deemed likely to non-close. A few attribute values and the corresponding scores are provided in the table of FIG. 11. The scores provided are masked to protect customer confidentiality. Based on the scheme suggested above, Interest Rate is the identified attribute for application Y. Thus, suggest lowering the interest rate offer. Given the teachings herein, the skilled artisan will be able to think of other schemes as well.

### Ranking, Classification, Workflows, and Prioritization

Both supervised and unsupervised techniques have been used for classification and ranking. The skilled artisan will be familiar with supervised techniques, including regressions and support vector machines respectively, from, for example, W. Greene, Econometric analysis, Prentice Hall, Inc., 2000, and J. Shawe-Taylor and N. Cristianini. Support vector machines and other kernel-based learning methods, Cambridge University Press, 2000. Likelihood and likelihood ratio based models have also been used. In fact, likelihood ratio is the minimum probability-of-error decision scheme for classification. The skilled artisan will be familiar with this concept from, for example, V. Poor, An Introduction to Signal Detection and Estimation, Springer texts in Electrical Engineering, 1994. Unsupervised techniques have been applied to a number of different domains, as the skilled artisan will appreciate from, for example, V. Iyengar et al., Analytics for audit and business controls in corporate travel and entertainment, Sixth Australasian Data Mining conference, 2007, wherein behavior shift models were used to determine exceptions in the travel and entertainment expenses of a company.

There are various known techniques for modeling, execution and optimization of workflows; the skilled artisan will be familiar with same from, for example, I.-M. A. Chen and V. M. Markowitz, Modeling scientific experiments with an object data model, In ICDE, pages 391-400, 1995; R. Agrawal at al., Mining process models from workflow logs, In EDBT, pages 469-483, 1998; and J. Cook and A. Wolf, Discovering models of software processes from event-based data, ACM Trans. Softw. Eng. Methodol., 7(3):215-249, 1998. Q. Shao et al. have studied the problem of optimizing workflow by reducing the number of steps to resolution in the context of problem tickets and resolution groups, in “Efficient ticket routing by resolution sequence mining,” In KDD, pages 605-613, 2008.

The problem of prioritizing multiclass applications or jobs that arrive to a queue, wherein associated with each class are due dates and service level penalties, has been addressed by leveraging scheduling heuristics such as Shortest Processing Time, Earliest Due date First, etc. (as in M. Pinedo, Scheduling theory, algorithms and systems, Prentice Hall, Inc, 1995) or asymptotic properties of Service Systems (as in A. Sheopuri et al., A new policy for the service request assignment problem with multiple severity level, due date and SLA penalty service requests, Winter Simulation Conference, 2008).

Given the teachings herein, a variety of implementations will be apparent to the skilled artisan.

### Recapitulation and Exemplary Block Diagram

Embodiments of the invention provide different ranking models that incorporate customer, product, environment and workflow attributes at any status in the MO process. At least some instances employ two workflow attributes, each with a state-space of dimension one, based on the number of visits to any status and a particular status (re-work) respectively. Incorporating these workflow attributes results in improvement of the density modeling technique by 4.8 percent in Average Precision over models that only incorporate customer, product and environment attributes, it being understood that results may vary in other embodiments. Incorporating environment attributes such as the U.S. federal interest rate results, in at least some instances, in improvement of the density modeling technique over those models that consider only customer and product specific attributes. The simple and scalable density modeling technique allows for easy identification of applications that are likely to non-close and consequent corrective action such as change in the attributes of the mortgage product being offered. Further, non-limiting exemplary experimental results indicate that the model is comparable to Support Vector Machines and superior to Logistic Regression for ranking.

FIG. 13 shows a block diagram 1300 of an exemplary system, according to an aspect of the invention. Ranking engine 1314 includes a scoring function 1306 and parameters of the prioritization model 1308. The scoring function is preferably implemented by providing a computer-readable storage medium with computer instructions to solve expressions (3), (5), and (6) above when loaded into memory and executed on one or more hardware processors. The scoring function operates on the in-process loans 1302 based on the parameters 1308 which can be obtained by training on the historical data for processed loans 1304. The in-process loans 1302 typically include at least the customer and product attributes 1316, 1318; preferably one or more environmental attributes 1320, and more preferably one or more workflow attributes 1322 are also taken into consideration as discussed above. The output of function 1306 of engine 1314 is a prioritized list of in-process loans, by status, as shown at 1310. The prioritized lists form the basis for processing, including possible corrective actions for loans that may be otherwise likely not to close, as discussed above. This is indicated at block 1312; the output thereof is directed to store 1304 if processing is complete, or to the next status in store 1302 if processing is still in progress.

Note that the block 1310 would typically include a ranked list of loans for each of the different statuses. For example, in FIG. 2, there might be three loans at status 204, two loans at status 206, and ten loans at status 208. The data structure 1310 might then include three lists; namely, a first ranked list of the three loans at status 204, a second ranked list of the two loans at status 206, and a third ranked list of the ten loans at status 208. Note also that blocks 1316, 1318, 1320, 1322, 1302, 1304, 1310, and 1312 each generally represent a separate data structure including data stored on a computer-readable storage medium or multiple such media. Note also that in one or more embodiments, training logic to implement step 1404 is provided; for example, in the form of a distinct software module as described below. The output of same is the data file 1308 containing the parameters.

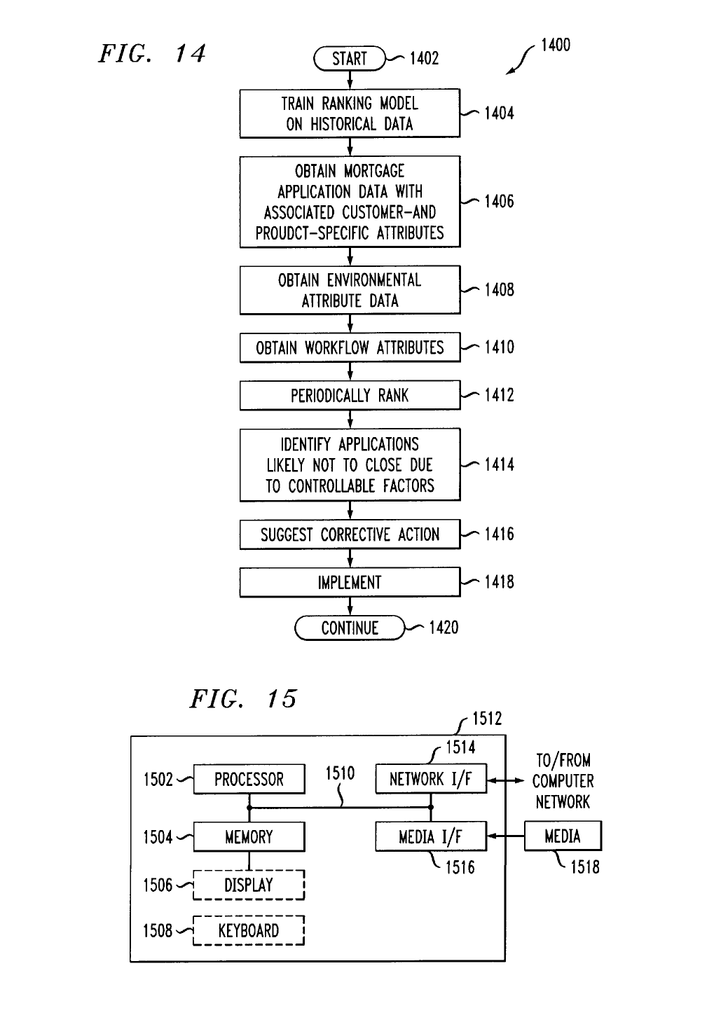

FIG. 14 shows a flow chart 1400 of exemplary method steps, according to an aspect of the invention. Processing begins at step 1402. Given the discussion thus far, it will be appreciated that, in general terms, an exemplary method includes the step 1406 of obtaining data representative of a plurality of mortgage applications. The applications participate in a mortgage origination process, and each of the applications has associated therewith customer-specific attributes and product-specific attributes. The mortgage origination process has a plurality of statuses. Step 1408 includes obtaining data representative of at least one environmental attribute. Step 1412 includes ranking each given one of the mortgage applications in a given one of the plurality of statuses at a given time, by likelihood of not closing, based at least on the customer-specific attributes, the product-specific attributes, and the environmental attribute(s). Step 1414 includes identifying those of the mortgage applications likely not to close which are likely not to close due to non-exogenous attributes. Step 1416 includes facilitating suggesting, for at least some of the mortgage applications likely not to close due to non-exogenous attributes, a modification of at least one corresponding one of the product-specific attributes, to enhance the likelihood of closing. Processing continue at 1420.

Optional but preferred step 1410 includes obtaining, for each of the mortgage applications, data representative of at least a first workflow attribute. In this case, the ranking 1412 is further based on the at least first workflow attribute. Preferably, the plurality of statuses include rework, and step 1410 further includes obtaining, for each of the mortgage applications, data representative of at least a second workflow attribute. In such a case, the ranking 1412 is further based on the second workflow attribute, the first workflow attribute is the total number of visits of a given one of the mortgage applications to any one of the statuses, and the second workflow attribute is the total number of visits of a given one of the mortgage applications to the rework status.

The customer-specific attributes may include, for example, credit score, assets less liabilities over income, appraised value less sale price, and debt to income ratio. The product-specific attributes may include, for example, rate type, interest rate, property type loan amount, cashout, loan to value ratio, and finance charge. The at least one environmental attribute may include, for example, a prevailing governmental interest rate such as the above-mentioned US Federal interest rate.

A variety of techniques may be used for ranking step 1412; for example, likelihood ratio ranking with a likelihood ratio ranker, support vector machine ranking with a support vector machine ranker, or logistic regression ranking with a logistic regression ranker. In each case, the ranker may be trained on historical data, as shown at optional step 1404. Optional step 1418 includes implementing corrective action based upon the suggestion 1418.

It is preferred that the steps be repeated periodically for each application at a given status. In a presently preferred embodiment, the period is nightly (e.g., daily processing every night). However, other approaches can be employed; for example, weekly, in real time, and the like.

Step 1404 may be carried out with block 1308 based on the historical data 1304. Step 1406 may be carried out by a suitable input/output (I/O) routine associated with engine 1314, obtaining data from stores 1302, 1316, and/or 1318. Step 1408 may be carried out with the I/O routine obtaining data from stores 1302 and/or 1320. Step 1410 may be carried out with the I/O routine obtaining data from stores 1302 and/or 1322. Steps 1412 and 1414 may be carried out with scoring function 1314. In at least some instances, the suggestion and implementation, respectively, in steps 1416 and 1418 can be implemented using manual intervention, wherein a manager decides what to do. Such managerial action can be facilitated by displaying the results of the process to the manager on a computer screen or printout, for example, and/or receiving from the manager input indicative of the suggestion(s) and/or implementation(s).

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 15, such an implementation might employ, for example, a processor 1502, a memory 1504, and an input/output interface formed, for example, by a display 1506 and a keyboard 1508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1502, memory 1504, and input/output interface such as display 1506 and keyboard 1508 can be interconnected, for example, via bus 1510 as part of a data processing unit 1512. Suitable interconnections, for example via bus 1510, can also be provided to a network interface 1514, such as a network card, which can be provided to interface with a computer network, and to a media interface 1516, such as a diskette or CD-ROM drive, which can be provided to interface with media 1518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1502 coupled directly or indirectly to memory elements 1504 through a system bus 1510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1508, displays 1506, pointing devices, and the like) can be coupled to the system either directly (such as via bus 1510) or through intervening I/O controllers (omitted for clarity).

Network adapters such as network interface 1514 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 1512 as shown in FIG. 15) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 1518 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in FIG. 13 and/or described in connection therewith. The method steps can then be carried out using the distinct software modules and/or sub-modules of the system, as described above, executing on one or more hardware processors 1502. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising the steps of:
obtaining data representative of a plurality of mortgage applications, said applications participating in a mortgage origination process, each of said applications having associated therewith customer-specific attributes and product-specific attributes, said mortgage origination process having a plurality of statuses;
obtaining data representative of at least one environmental attribute;
ranking each given one of said mortgage applications in a given one of said plurality of statuses at a given time, by likelihood of not closing, based at least on said customer-specific attributes, said product-specific attributes, and said at least one environmental attribute;
identifying those of said mortgage applications likely not to close which are likely not to close due to non-exogenous attributes; and
facilitating suggesting, for at least some of said mortgage applications likely not to close due to non-exogenous attributes, a modification of at least one corresponding one of said product-specific attributes, to enhance a likelihood of closing.

2. The method of claim 1, further comprising obtaining, for each of said mortgage applications, data representative of at least a first workflow attribute, wherein said ranking is further based on said at least first workflow attribute.

3. The method of claim 2, wherein said plurality of statuses include rework, further comprising obtaining, for each of said mortgage applications, data representative of at least a second workflow attribute, wherein:
said ranking is further based on said at least second workflow attribute;
said first workflow attribute comprises a total number of visits of a given one of said mortgage applications to any one of said statuses; and
said second workflow attribute comprises a total number of visits of a given one of said mortgage applications to said rework status.

4. The method of claim 3, wherein said customer-specific attributes comprise credit score, assets less liabilities over income, appraised value less sale price, and debt to income ratio.

5. The method of claim 3, wherein said product-specific attributes comprise rate type, interest rate, property type loan amount, cashout, loan to value ratio, and finance charge.

6. The method of claim 3, wherein said at least one environmental attribute comprises a prevailing governmental interest rate.

7. The method of claim 3, wherein said ranking comprises likelihood ratio ranking with a likelihood ratio ranker, further comprising training said likelihood ratio ranker on historical data.

8. The method of claim 3, wherein said ranking comprises support vector machine ranking with a support vector machine ranker, further comprising training said support vector machine ranker on historical data.

9. The method of claim 3, wherein said ranking comprises logistic regression ranking with a logistic regression ranker, further comprising training said logistic regression ranker on historical data.

10. The method of claim 1, further comprising providing a system, wherein the system comprises distinct software modules, each of the distinct software modules being embodied on a computer-readable storage medium, and wherein the distinct software modules comprise an input-output module and a scoring function module;
wherein:
said obtaining of said data representative of said plurality of mortgage applications, and said obtaining of said data representative of said at least one environmental attribute are carried out by said input-output module executing on at least one hardware processor; and
said ranking and identifying are carried out by said scoring function module executing on said at least one hardware processor.

11. A computer program product comprising a computer readable storage medium having computer readable program code embodied therewith, said computer readable program code comprising:
computer readable program code configured to obtain data representative of a plurality of mortgage applications, said applications participating in a mortgage origination process, each of said applications having associated therewith customer-specific attributes and product-specific attributes, said mortgage origination process having a plurality of statuses;
computer readable program code configured to obtain data representative of at least one environmental attribute;
computer readable program code configured to rank each given one of said mortgage applications in a given one of said plurality of statuses at a given time, by likelihood of not closing, based at least on said customer-specific attributes, said product-specific attributes, and said at least one environmental attribute;
computer readable program code configured to identify those of said mortgage applications likely not to close which are likely not to close due to non-exogenous attributes; and
computer readable program code configured to facilitate suggesting, for at least some of said mortgage applications likely not to close due to non-exogenous attributes, a modification of at least one corresponding one of said product-specific attributes, to enhance a likelihood of closing.

12. The computer program product of claim 11, further comprising computer readable program code configured to obtain, for each of said mortgage applications, data representative of at least a first workflow attribute, wherein said ranking is further based on said at least first workflow attribute.

13. The computer program product of claim 12, wherein said plurality of statuses include rework, further comprising computer readable program code configured to obtain, for each of said mortgage applications, data representative of at least a second workflow attribute, wherein:
said ranking is further based on said at least second workflow attribute;
said first workflow attribute comprises a total number of visits of a given one of said mortgage applications to any one of said statuses; and
said second workflow attribute comprises a total number of visits of a given one of said mortgage applications to said rework status.

14. The computer program product of claim 13, wherein said customer-specific attributes comprise credit score, assets less liabilities over income, appraised value less sale price, and debt to income ratio.

15. The computer program product of claim 13, wherein said product-specific attributes comprise rate type, interest rate, property type loan amount, cashout, loan to value ratio, and finance charge.

16. The computer program product of claim 13, wherein said at least one environmental attribute comprises a prevailing governmental interest rate.

17. The computer program product of claim 13, wherein said computer readable program code configured to rank comprises computer readable program code configured to likelihood ratio rank with a likelihood ratio ranker, further comprising computer readable program code configured to train said likelihood ratio ranker on historical data.

18. The computer program product of claim 13, wherein said computer readable program code configured to rank comprises computer readable program code configured to support vector machine rank with a support vector machine ranker, further comprising computer readable program code configured to train said support vector machine ranker on historical data.

19. The computer program product of claim 13, wherein said computer readable program code configured to rank comprises computer readable program code configured to logistic regression rank with a logistic regression ranker, further comprising computer readable program code configured to train said logistic regression ranker on historical data.

20. An apparatus comprising:
a memory; and
at least one processor, coupled to said memory, and operative to:
obtain data representative of a plurality of mortgage applications, said applications participating in a mortgage origination process, each of said applications having associated therewith customer-specific attributes and product-specific attributes, said mortgage origination process having a plurality of statuses;
obtain data representative of at least one environmental attribute;
rank each given one of said mortgage applications in a given one of said plurality of statuses at a given time, by likelihood of not closing, based at least on said customer-specific attributes, said product-specific attributes, and said at least one environmental attribute;
identify those of said mortgage applications likely not to close which are likely not to close due to non-exogenous attributes; and
facilitate suggesting, for at least some of said mortgage applications likely not to close due to non-exogenous attributes, a modification of at least one corresponding one of said product-specific attributes, to enhance a likelihood of closing.

21. The apparatus of claim 20, wherein said at least one processor is further operative to obtain, for each of said mortgage applications, data representative of at least a first workflow attribute, wherein said ranking is further based on said at least first workflow attribute.

22. The apparatus of claim 21, wherein said plurality of statuses include rework, wherein said at least one processor is further operative to obtain, for each of said mortgage applications, data representative of at least a second workflow attribute, wherein:
said ranking is further based on said at least second workflow attribute;
said first workflow attribute comprises a total number of visits of a given one of said mortgage applications to any one of said statuses; and
said second workflow attribute comprises a total number of visits of a given one of said mortgage applications to said rework status.

23. The apparatus of claim 20, further comprising a plurality of distinct software modules, each of the distinct software modules being embodied on a computer-readable storage medium, and wherein the distinct software modules comprise an input-output module and a scoring function module;
wherein:
said at least one processor is operative to obtain said data representative of said plurality of mortgage applications, and obtain said data representative of said at least one environmental attribute by executing said input-output module; and
said at least one processor is operative to ranking and identify by executing said scoring function module on said at least one hardware processor.

24. An apparatus comprising:
means for obtaining data representative of a plurality of mortgage applications, said applications participating in a mortgage origination process, each of said applications having associated therewith customer-specific attributes and product-specific attributes, said mortgage origination process having a plurality of statuses;
means for obtaining data representative of at least one environmental attribute;
means for ranking each given one of said mortgage applications in a given one of said plurality of statuses at a given time, by likelihood of not closing, based at least on said customer-specific attributes, said product-specific attributes, and said at least one environmental attribute;
means for identifying those of said mortgage applications likely not to close which are likely not to close due to non-exogenous attributes; and
means for facilitating suggesting, for at least some of said mortgage applications likely not to close due to non-exogenous attributes, a modification of at least one corresponding one of said product-specific attributes, to enhance a likelihood of closing.

25. The apparatus of claim 24, further comprising means for obtaining, for each of said mortgage applications, data representative of at least a first workflow attribute, wherein said ranking is further based on said at least first workflow attribute.
